(19) United States
(12) Patent Application Publication
(10) Pub. No.: US 2020/0234878 A1
(43) Pub. Date: Jul. 23, 2020

(54) INDUCTOR CHOKE COIL WIRE INTERFERENCE PREVENTION STRUCTURE

(71) Applicant: SURTEK CO., LTD., Chubei City (TW)

(72) Inventor: Wei-Yi CHOU, Chubei City (TW)

(21) Appl. No.: 16/250,835

(22) Filed: Jan. 17, 2019

(51) Int. Cl. H01F 41/04; H01F 17/04; H01F 37/00; H01F 27/02; H01F 41/02

(52) U.S. Cl. CPC H01F 41/046; H01F 17/04; H01F 2017/046; H01F 27/022; H01F 41/0246; H01F 37/00

(57) ABSTRACT

An inductor choke coil wire interference prevention structure includes a choke coil having a flat body portion wound into a continuous electrical coil portion, two end portions respectively downwardly extending from two opposite ends of the flat body portion and respectively bent into a respective soldering electrode. An extension tip is located on a distal end of each end portion remote from the flat body portion, and a layer of insulating film covers a contact surface of the end portion or an adjacent contact surface of the electrical coil portion to allow direct contact between the electrical coil portion and the contact surface of the end portion without causing electrical conduction or shorting.

### BACKGROUND OF THE INVENTION

### 1. Field of the Invention

The present invention relates to inductor technology and more particularly, to a choke coil wire interference prevention structure for a high-current, low-profile inductor.

### 2. Description of the Related Art

Inductors are used in high-tech computer products, mobile communication devices and portable devices, increasingly demanding light, thin, short and small-form characteristics. The prior art of U.S. Pat. No. 6,204,744B1 discloses a high current, low profile inductor that includes a wire coil 1 having an inner coil end 111 and an outer coil end 112. The inner coil end 111 and the outer coil end 112 are respectively soldered to respective connection ends 21, 22 of a lead frame 2, and the excessive extension portions of the connection ends 21, 22 of the lead frame 2 are then cut off, leaving the connection ends 21, 22 of the lead frame 2 at the inner coil end 111 and outer coil end 112 of the wire coil 1 respectively to form respective solder electrodes for bonding to a circuit board. According to this design, a soldering process is necessary to make the soldering electrodes, complicating the manufacturing process, increasing the manufacturing costs and leading to an increase in failure rates.

In addition, the prior art of CN1285086C discloses an improved structure of a choke coil for an inductor. As illustrated in FIG. 1, the choke coil 3 has extension tips 33, 34 at respective opposite end portions 31, 32 thereof. As illustrated in FIG. 3, the flat body portion of the choke coil 3 is wound into a continuous electrical coil portion 35; the extension tips 33, 34 are bent into respective flat metal wires that are directly used as soldering electrodes. Thus, the extension tips 33, 34 (soldering electrodes) are formed integrally with the choke coil 3.

In order to prevent polarity short circuits, as shown in FIG. 4, the connection end 21 of the wire coil 1 of U.S. Pat. No. 6,204,744B1 must be kept apart from the electrical coil portion 13 by an isolation height G. Similarly, in order to prevent polarity short circuits, as shown in FIG. 5, the extension tip 33 of the choke coil 3 of CN1285086C must be kept apart from the electrical coil portion 35 by an isolation height G. When the magnetic molding material 4 is molded onto the electrical coil portion 13 of the wire coil 1 of U.S. Pat. No. 6,204,744B1 or the electrical coil portion 35 of the choke coil 3 of CN1285086C to make an inductor, (as shown by the dotted lines in FIGS. 1 and 3 and the dotted lines in FIGS. 4 and 5), the connection end 21 of the wire coil 1 of U.S. Pat. No. 6,204,744B1 is isolated from the electrical coil portion 11 by the isolation height G (magnetic molding material 4); the extension tip 33 of the choke coil 3 of CN1285086C is isolated from the electrical coil portion 35 by the isolation height G (magnetic molding material 4). Due to the existence of the isolation height G, the overall height H of the wire coil 1 or choke coil 3 cannot be minimized, which is not suitable to the current requirements of high-tech computer products for being light, thin, short, and small. Further, as illustrated in FIG. 5, after the magnetic molding material 4 is molded onto the electrical coil portion 35 of the choke coil 3 according to CN1285086C, the magnetic molding material 4 fills the isolation height G between the extension tip 33 and the electrical coil portion 35. When the magnetic molding material 4 is energized, magnetic interference occurs between the extension tip 33 and the electrical coil portion 35 that affects the electromagnetic properties of the choke coil 3.

### SUMMARY OF THE INVENTION

Embodiments of the present invention have been accomplished in view of the above. It is therefore an objective of embodiments of the present invention to provide an inductor choke coil wire interference prevention structure, which comprises a choke coil comprising a flat body portion wound into a continuous electrical coil portion, two end portions respectively downwardly extending from two opposite ends of the flat body portion and respectively bent into a respective welding electrode and an extension tip located on a distal end of each end portion remote from the flat body portion, and a layer of an insulating film covering a contact surface of an end portion or an adjacent contact surface of the electrical coil portion for allowing direct contact between the contact surface of the end portion and the contact surface of the electrical coil portion without causing electrical conduction. The inductive choke coil wire interference prevention structure has the advantages of easy stamping, long tool life, space savings, easy winding, ease of control of the outer diameter, and no internal solder joints. The end portions are kept flush with the outer surface of the inductor. After the magnetic molding material fills the choke coil and is molded into shape, the end portions are exposed external to the the outer surface of the inductor for bonding purposes. Thus, inductors made according to embodiments of the present invention have large bonding areas, and their choke coils are provided with a wire interference preventive structure, thereby avoiding magnetic interference between the extension tips and the electrical coil portions. Thus, the inductor choke coil wire interference prevention structure of embodiments of the present invention is practical for making a high-performance, high-current, low-profile inductor that is suitable for use in high-tech computer products and portable devices.

### BRIEF DESCRIPTION OF THE DRAWINGS

FIG. 1 is a schematic drawing illustrating a high current, low profile inductor according to U.S. Pat. No. 6,204,744B1.

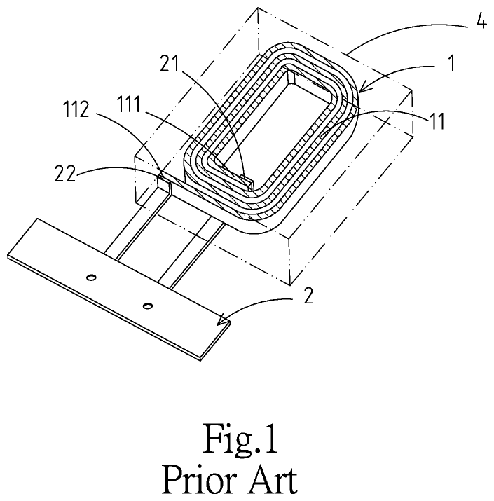

FIG. 2 is a schematic drawing illustrating an unwound choke coil according to CN1285086C.

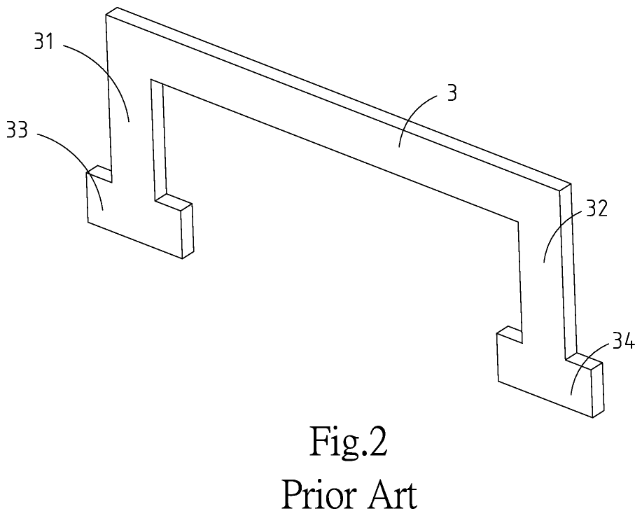

FIG. 3 is a schematic drawing illustrating the choke coil material of CN1285086C wound into a choke coil.

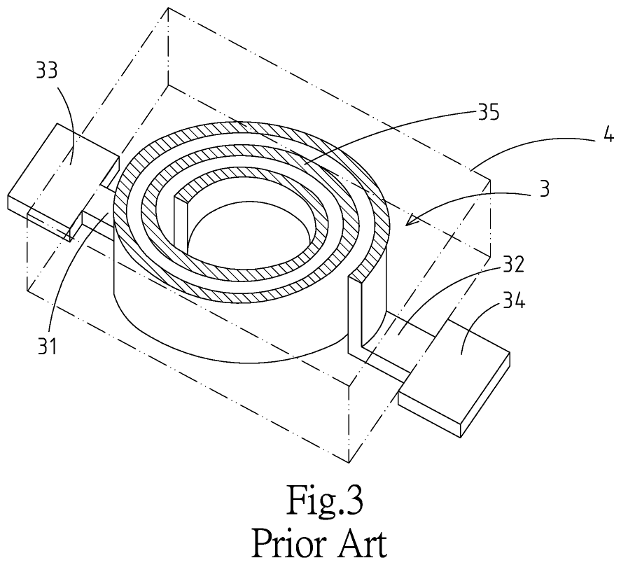

FIG. 4 is a schematic sectional view illustrating the magnetic molding material molded in the wire coil according to U.S. Pat. No. 6,204,744B1.

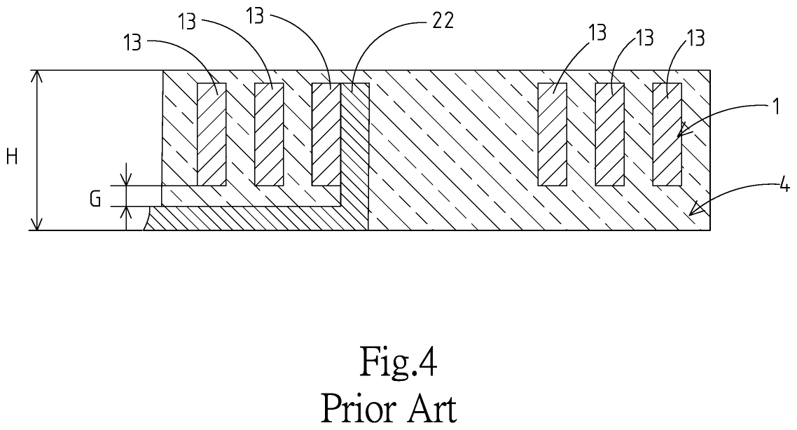

FIG. 5 is a schematic sectional view illustrating the magnetic molding material molded in the choke coil according to CN1285086C.

FIG. 6 is a schematic elevational view of an inductor using an inductor choke coil wire interference prevention structure in accordance with an embodiment of the present invention.

FIG. 7 is a schematic drawing illustrating a layer of insulating film covering a contact surface of one end portion of an unwound choke oil in accordance with an embodiment of the present invention.

FIG. 8 is a schematic drawing illustrating a layer of insulating film covering an adjacent contact surface of a flat body portion of an unwound choke coil in accordance with an embodiment of the present invention.

FIG. 9 illustrates a flat body portion of the choke coil wound into an electrical portion according to an embodiment of the present invention.

FIG. 10 is a schematic sectional view illustrating magnetic molding material molded onto a choke coil according to an embodiment of the present invention.

FIG. 11 corresponds to FIG. 10, illustrating extension tips bent into shape.

FIG. 12 is an enlarged view of a portion of FIG. 10, illustrating positioning of the layer of insulating film.

### DETAILED DESCRIPTION OF THE PREFERRED EMBODIMENT

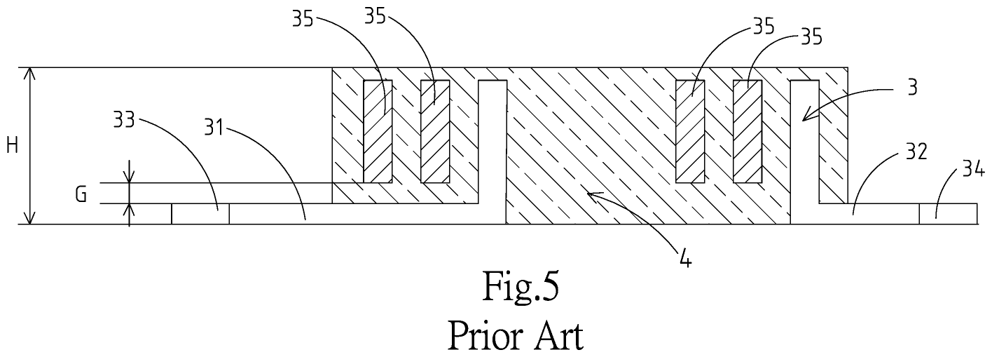

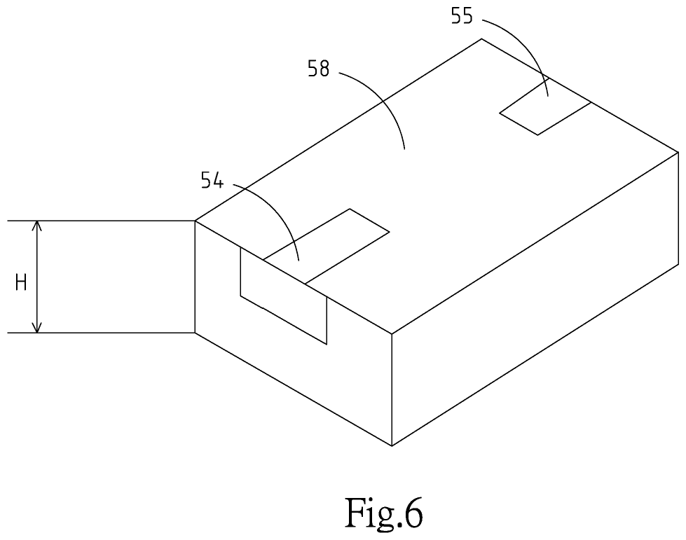

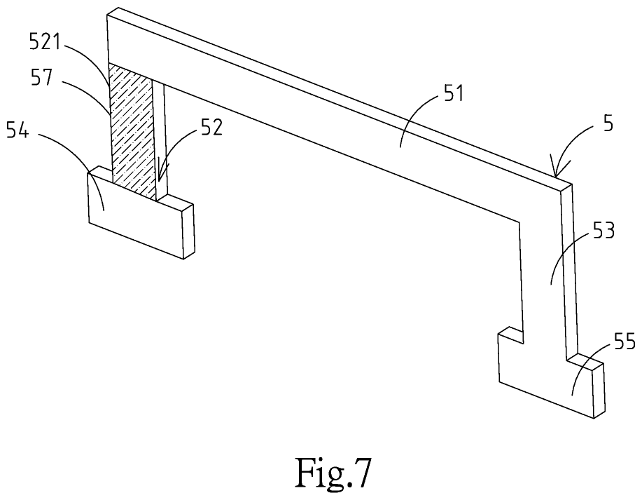

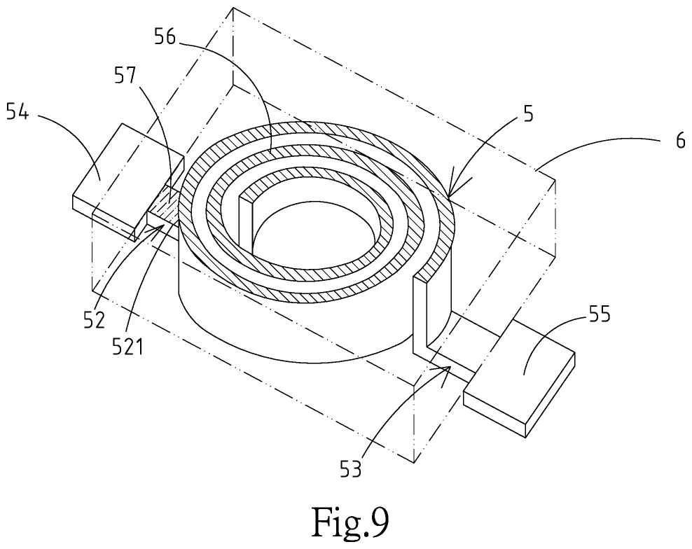

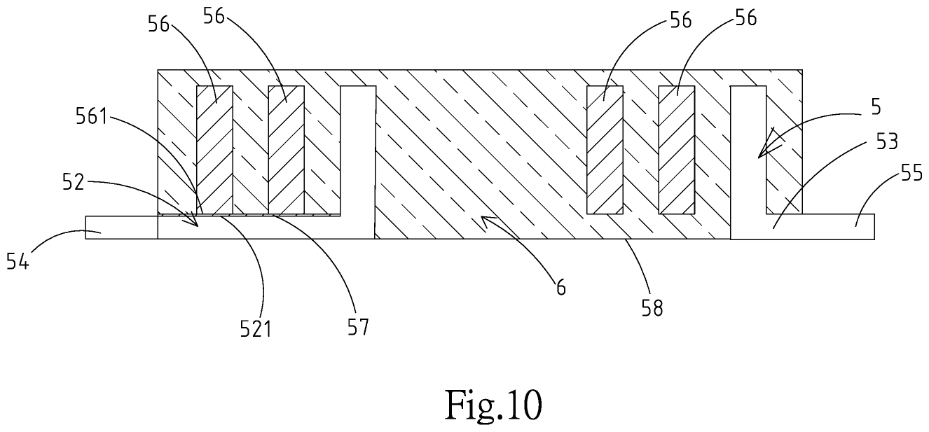

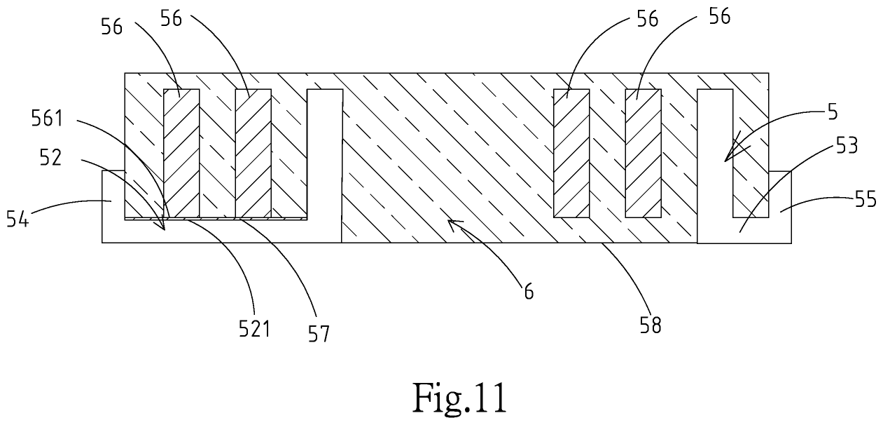

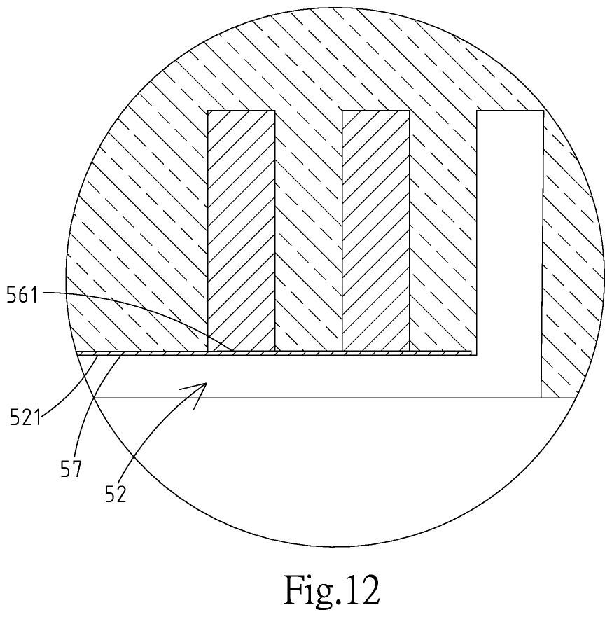

Referring to FIGS. 6-12, an inductor choke coil wire interference prevention structure in accordance with an embodiment of the present invention is shown. The inductor choke coil wire interference prevention structure provides a choke coil 5 with a conductive wire interference structure. As illustrated in FIG. 7, the choke coil 5 comprises a flat body portion 51, two opposing end portions 52, 53 respectively downwardly extending from two opposite ends of the flat body portion 51, and two extension tips 54, 55 respectively located on respective distal ends of the end portions 51, 53 remote from the flat body portion 51. The flat body portion 51 is wound into a continuous electrical coil portion 56. The two end portions 52, 53 are respectively bent into a respective welding electrode. A contact surface 521 of one end portion 52 of the choke coil 5 electrical coil portion 56 is coated with a layer of insulating film 57 so that the contact surface 521 of the end portion 52 does not provide a gap (corresponding to the isolation height G of the choke coil of the inductor according to the prior art), i.e., the insulating film 57 is kept in direct contact with the contact surface 521 of the end portion 52 so that the contact surface 521 of the end portion 52 can be directly kept in direct contact with other objects without causing electrical conduction or shorts. As illustrated in FIGS. 6 and 9, the end portions 52, 53 are bent into respective soldering electrodes and kept flush with the outer surface 58 of the inductor (see also FIG. 5). Thus, a magnetic molding material 6 is filled into the electrical coil portion 56 of the choke coil 5 (see the imaginary line in FIG. 9 and FIGS. 10 and 11), and then molded into the desired inductor. According to this method, the overall height H of the choke coil 5 is effectively reduced. Further, the end portions 52, 53 are exposed external to the outer surface 58 of the inductor. Therefore, the inductor has a large bonding area. Further, as shown in FIG. 10, the layer of insulating film 57 is isolated between the extension tip 54 and electrical coil portion 56 of the choke coil 5. Because the insulating film 57 is not a magnetic material, the extension portion 54 and the electrical coil portion 56 do not cause electromagnetic interference during the energization operation due to electromagnetic effects. Therefore, the choke coil is suitable for making a high-performance, high-current, low-profile inductor for use in a high-tech computer product.

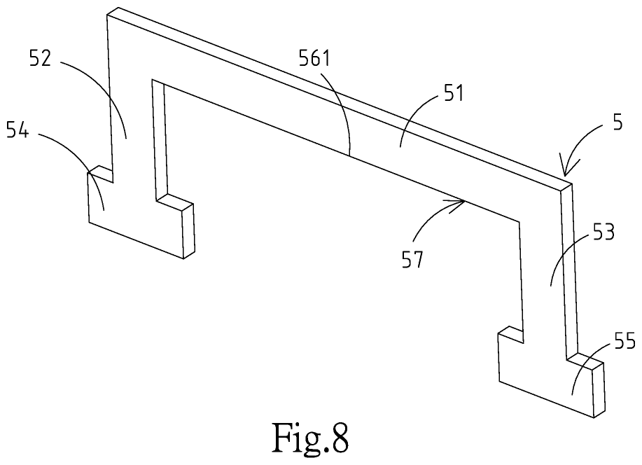

In this embodiment, the insulating film 57 is plated onto the contact surface 521 of the end portion 52 by anodization, as illustrated in FIG. 7. Alternatively, as shown in FIG. 8, the insulating film 57 can be plated onto the contact surface 561 of the electrical coil portion 56 by anodization. The insulating film 57 can be an oxide, nitride or carbide material for anodization. In this embodiment, a copper material is used and subjected to an anodizing treatment, with the electroplating treatment chemical formula of the anode treatment being Cu+2 NaOH to form a Na2CuO2+H2O, and then the Na2CuO2+H2O is dehydrated to form a CuO+2 NaOH, that is, an insulating composition of copper oxide for insulating film 57.

Alternatively, the insulating film 57 can be coated onto the contact surface 521 of the end portion 52 or the adjacent contact surface in contact with the contact surface 521 of the end portion 52 using a coating process. In the example shown in FIG. 7, the insulating film 57 is coated onto the contact surface 521 of the end portion 52 using a coating process. In the example shown in FIG. 8, the insulating film 57 is contacted with the contact surface 561 of the electrical coil portion 56 using a coating process. Further, the insulating film 57 can be a dry film material.

In still another embodiment, the insulating film 57 described above may also be coated onto the contact surface 521 of the end portion 52 or the adjacent contact surface in contact with the contact surface 521 of the end portion 52 using a solder mask (S/M) process. On the contact surface, for example, as shown in FIG. 7, the insulating film 57 can be coated on the contact surface 521 of the end portion 52 using a solder mask (S/M) process or coated on the contact surface 561 of the electrical coil portion 56 using a solder mask (S/M) process, as shown in FIG. 8. The insulating film 57 can be a resin material.

In conclusion, embodiments of the invention provide an inductor choke coil wire interference prevention structure, which comprises a choke coil comprising an electrical coil portion, two end portions respectively extending from two opposite ends of the electrical coil portion and respectively bent into a respective soldering electrode and an extension tip located on a distal end of each end portion remote from the electrical coil portion, and a layer of insulating film coated onto a contact surface of one end portion of the choke coil. The inductive choke coil wire interference prevention structure has the advantages of easy stamping, long tool life, space savings, ease of winding, easy control of the outer diameter, and no internal solder joints. The end portions are kept flush with the outer surface of the inductor. After the magnetic molding material is filled into the choke coil and molded into shape, the end portions are exposed external to the outer surface of the inductor for bonding. Thus, the inductor made according to embodiments of the present invention has a large bonding area, and its choke coil is provided with a wire interference preventive structure, avoiding magnetic interference between the extension tips and the electrical coil portion. Thus, the inductor choke coil wire interference prevention structure of the present invention is well-suited for making a high-performance, high-current, low-profile inductor.

What the invention claimed is:

1. An inductor choke coil wire structure, comprising a choke coil comprising a flat body portion wound into a continuous electrical coil portion, two end portions respectively downwardly extending from two opposite ends of said flat body portion and respectively bent into respective soldering electrodes, an extension tip located on a distal end of each said end portion remote from said flat body portion, and an insulating film selectively covering a contact surface of said end portion or an adjacent contact surface of said electrical coil portion.

2. The inductor choke coil wire structure as claimed in claim 1, wherein said insulating film is plated onto said adjacent contact surface of said electrical coil portion in contact with one said end portion by anodization of the wire metal.

3. The inductor choke coil wire structure as claimed in claim 1, wherein said insulating film is plated onto said contact surface of said end portion by anodization of the wire metal.

4. The inductor choke coil wire structure as claimed in claim 2, wherein said insulating film is an oxide, nitride, or carbide material.

5. The inductor choke coil wire structure as claimed in claim 1, wherein said insulating film is coated onto said adjacent contact surface of said electrical coil portion using a coating process.

6. The inductor choke coil wire structure as claimed in claim 1, wherein said insulating film is coated onto said contact surface of one said end portion using a coating process.

7. The inductor choke coil wire structure as claimed in claim 5, wherein said insulating film is a dry film material.

8. The inductor choke coil wire structure as claimed in claim 1, wherein said insulating film is coated onto said adjacent contact surface of said electrical coil portion using a solder mask (S/M) process.

9. The inductor choke coil wire structure as claimed in claim 1, wherein said insulating film is coated onto said contact surface of one said end portion using a solder mask (S/M) process.

10. The inductor choke coil wire structure as claimed in claim 1, wherein said insulating film is a resin material.
